(19) United States
(12) Patent Application Publication
(10) Pub. No.: US 2025/0370531 A1
(43) Pub. Date: Dec. 4, 2025

(54) ULTRA LOW POWER INTEGRATED CIRCUIT, POWER SAVING METHOD FOR INTEGRATED CIRCUIT AND TOUCH DISPLAY DRIVING CIRCUIT USING THE SAME

(71) Applicant: FOCALTECH SYSTEMS CO., LTD., Zhubei City (TW)

(72) Inventors: FANG-YI SU, Zhubei City (TW); KAI-XIANG YANG, Zhubei City (TW); CHENG-TAI HUANG, Zhubei City (TW)

(21) Appl. No.: 19/091,416

(22) Filed: Mar. 26, 2025

(30) Foreign Application Priority Data
May 29, 2024 (TW) 113119886

(51) Int. Cl. G06F 1/3296

(52) U.S. Cl. CPC G06F 1/3296

(57) ABSTRACT

The preferred embodiment of the present invention relates to an ultra low power integrated circuit, a power saving method for integrated circuit and a touch display driving circuit using the same. The ultra-low power integrated circuit comprises two functional blocks. The first functional block is disposed within the first power ring and stores configuration settings. The power consumption control block is disposed within the second power ring, which is constantly powered on. When switching from normal mode to low power mode, a series of procedures are executed: First, the power consumption control block temporarily stores the configuration settings of the first functional block and cuts off its power supply; it then reduces its own clock frequency and waits for a preset period of time; after that, it increases the clock frequency, powers on the first functional block, and loads the configuration settings; the first functional block then performs a wake-up determination, and if it is not to be woken up, the previous steps are repeated, effectively saving power.

### CROSS-REFERENCE TO RELATED APPLICATIONS

This application claims priority of No. 113119886 filed in Taiwan R.O.C. on May 29, 2024 under 35 USC 119, the entire content of which is hereby incorporated by reference.

### BACKGROUND OF THE INVENTION

### Field of the Invention

The present invention relates to the technology for energy-saving in integrated circuits, more particularly, the present invention relates to an ultra-low power integrated circuit, power saving method for integrated circuit and touch display driving circuit using the same.

### Description of the Related Art

In conventional power domain architecture design, different power consumption modes are typically addressed by appropriately planning and arranging the modules. For example, for low-power modes, designers predefine which areas need to be powered off and which areas require continuous power supply. Such planning needs to be implemented at the Register Transfer Level (RTL) in the hardware description language.

The implementation process usually requires large-scale modifications and reorganization of the original module level, breaking the original module structure. The logic circuits originally dispersed across different modules need to be reclassified based on whether they belong to power-off areas, with the logic circuits entering the power-off area being grouped together, while those circuits requiring continuous power supply are grouped in another block. This reorganization process not only consumes significant human resources, but also requires considerable time for design, simulation, verification, and debugging.

Due to the traditional power domain architecture design approach, which involves extensive manual modifications to the original RTL code and manual reorganization of logic circuits, it is easy to overlook or make mistakes. Even after repeated simulations and verifications, it is difficult to ensure complete accuracy, presenting a high risk. This not only delays the entire design process, but also potentially leads to functional abnormalities or reliability issues in the final product.

The main drawback of the traditional power domain architecture design approach is that it requires extensive manual modifications to the original RTL code, disrupting the original module structure, which significantly increases design complexity and raises the risk of omissions and errors. This method is not only inefficient but also difficult to ensure the correctness and reliability of the design.

### BRIEF SUMMARY OF THE INVENTION

The objective of a preferred embodiment of the present invention is to provide an ultra-low power integrated circuit, power saving method for integrated circuit and touch display driving circuit using the same, for reducing the overall power consumption of the integrated circuit, simplifying the design process, and improving product reliability.

In view of this, an exemplary embodiment of the present invention is to provide a low-power integrated circuit. The low-power integrated circuit includes a functional circuit block and a power consumption control block. The power consumption control block remains powered on. When the operation mode of the low-power integrated circuit is switched from a normal mode to a low-power mode, an operation of the low-power integrated circuit comprises: a first procedure: the power consumption control block performing a power-off sequence on the functional circuit block, then turns off the power supply to the power consumption control block, thereby completely powering down the functional circuit block; a second procedure: reducing the operating clock frequency of the power consumption control block; a third procedure: waiting for a preset time; a fourth procedure: increasing the operating clock frequency of the power consumption control block, and the power consumption control block performing a power-on sequence on the functional circuit block; and a fifth procedure: the functional circuit block performing a wake-up determination, and if the wake-up determination results in no wake-up, returning to the first procedure.

Another exemplary embodiment of the present invention provides a touch display driving circuit for controlling a touch display panel, wherein the touch display driving circuit includes a functional circuit block and a power consumption control block, wherein the power consumption control block remains powered on. When the touch display driving circuit enters a low-power mode from a normal mode, the touch display driving circuit cyclically switches from a pre-wake-up mode and a power-off mode, wherein, in the power-off mode, the power consumption control block controls the functional circuit block to be completely powered off, and in the pre-wake-up mode, the power consumption control block performs touch detection of multiple frames on the touch display panel, the touch detection comprising: determining whether a touch point area in the frames reaches a touch area threshold; determining whether at least one preset touch point reaches a touch count threshold; and when the touch point area reaches the touch area threshold and at least one preset touch point reaches the touch count threshold, performing a wake-up sequence and returning to the normal mode.

Another exemplary embodiment of the present invention provides a power-saving method for an integrated circuit. The method includes: dividing the integrated circuit into a functional circuit block and a power consumption control block which remains powered on;

when the integrated circuit enters a low-power mode from a normal mode, the power consumption control block performs procedures, comprising: a first procedure: performing a power-off sequence for the functional circuit block, then turning off power supply to completely power off the functional circuit block; a second procedure: reducing an operating clock frequency of the power consumption control block; a third procedure: waiting for a preset time; a fourth procedure: increasing the operating clock frequency of the power consumption control block, and the power consumption control block performing a power-on sequence for the functional circuit block; and a fifth procedure: performing a wake-up determination, and if the wake-up determination results in no wake-up, returning to the first procedure, wherein the power consumption control block is not powered off.

Another exemplary embodiment of the present invention provides a power-saving method for a touch display driver circuit, wherein the touch display driver circuit is used for controlling a touch display panel, the touch display driver circuit comprises a functional circuit block that stores a configuration setting and a power consumption control block, wherein the power consumption control block remains powered on, wherein the power-saving method for the touch display driver circuit includes: when entering a low-power mode from a normal mode, cyclically switching between a pre-wake-up mode and a power-off mode, wherein in the power-off mode, the power consumption control block controls the functional circuit block to be completely powered off, and in the pre-wake-up mode, performing touch detection of multiple frames on the touch display panel; wherein the touch detection comprises: determining whether a touch area in the frames reaches a touch area threshold; and determining whether at least one preset touch point reaches a touch count threshold; when the touch point area reaches the touch area threshold, and at least one preset touch point reaches the touch count threshold, performing a wake-up sequence, and returning to the normal mode.

In the low-power integrated circuit and the power-saving method according to the preferred embodiment of the present invention, the functional circuit block includes an analog front-end circuit block and a digital circuit block. The digital circuit block includes a configuration storage memory block for temporarily storing a configuration setting. The first procedure further includes: the power consumption control block sequentially performing the steps of: turning off the power to the analog front-end circuit block; turning off the clock signal to the digital circuit block; storing the configuration setting.

In the low-power integrated circuit and the power-saving method according to the preferred embodiment of the present invention, the power consumption control block performing the power-on sequence sequentially comprises steps: turning on a power of the digital circuit block; loading the configuration setting into the digital circuit block; turning on a clock signal of the digital circuit block; and turning on a power of the analog front-end circuit block. In a preferred embodiment, the functional circuit block further includes a microprocessor circuit, and the touch display panel is controlled by a mobile system, and the mobile system includes a central processing unit. The wake-up sequence includes: unlocking a reset of the central processing unit, enabling the central processing unit to operate normally, and then the central processing unit issuing an interrupt request to the microprocessor circuit; and when the microprocessor circuit receives the interrupt request, re-executing a ROM code program and loading the ROM code program into writable memory.

In summary, the embodiment of the present invention provides an ultra-low power integrated circuit design method. By dividing the circuit into power consumption control blocks and functional circuit blocks, and using separate power supply rails, it is possible to selectively power off or reduce clock frequency in low power mode, such that the significant energy savings can be achieved. When entering the low power mode, the power consumption control block first stores the configuration settings of the functional block and performs a power-off sequence to turn off the power supply to the functional block, completely powering it down. At the same time, the operating clock frequency of the power consumption control block is also appropriately reduced to further lower power consumption. After a preset time, the clock frequency of the power consumption control block will be raised, and a power-up procedure for the functional circuit block is performed, and the previously stored configuration settings is loaded to resume system operation. If the system still does not need to wake up at this point, it will re-enter the low power mode and repeat the above cycle. This intelligent energy-saving design ensures minimal power consumption in low power mode while allowing for quick wake-up, without affecting normal operation. Compared with conventional energy-saving modes, the present invention can achieve greater power reduction, extending battery life, making it particularly suitable for portable devices with limited power, such as wearable devices and smartphones, significantly enhancing the user experience.

The above-mentioned and other objects, features and advantages of the present invention will become more apparent from the following detailed descriptions of preferred embodiments thereof taken in conjunction with the accompanying drawings.

### BRIEF DESCRIPTION OF THE SEVERAL VIEWS OF THE DRAWINGS

The accompanying drawings are provided to assist those skilled in the relevant technical field in further understanding the present invention, and are incorporated as part of the specification of the invention. The drawings illustrate exemplary embodiments of the present invention and are used together with the description to explain the principles of the invention.

FIG. 1A illustrates a block diagram depicting an ultra-low power integrated circuit according to a preferred embodiment of the present invention.

FIG. 1B illustrates a block diagram depicting an ultra-low power integrated circuit according to a preferred embodiment of the present invention.

FIG. 1C illustrates a block diagram depicting an ultra-low power integrated circuit according to a preferred embodiment of the present invention.

FIG. 2 illustrates a state diagram depicting the finite state machine of the ultra-low power integrated circuit according to a preferred embodiment of the present invention.

FIG. 3 illustrates a flowchart depicting the power saving method for an integrated circuit according to a preferred embodiment of the present invention.

FIG. 4 illustrates a flowchart depicting the sub-steps of step S303 of the power saving method for an integrated circuit according to a preferred embodiment of the present invention.

FIG. 5 illustrates a flowchart depicting the sub-steps of step S306 of the power saving method for an integrated circuit according to a preferred embodiment of the present invention.

FIG. 6 illustrates a flowchart depicting the sub-steps of step S308 of the power saving method for an integrated circuit according to a preferred embodiment of the present invention.

FIG. 7 illustrates a schematic diagram depicting a touch detection result of step S308 according to a preferred embodiment of the present invention.

FIG. 8 illustrates a schematic diagram depicting a touch detection result of step S308 according to a preferred embodiment of the present invention.

### DETAILED DESCRIPTION OF THE INVENTION

In the detailed description of the exemplary embodiments of the present invention, the exemplary embodiments will be illustrated in the accompanying drawings. Where possible, the same reference numerals are used in the drawings and the description to refer to the same or similar components. Furthermore, the methods of the exemplary embodiments are merely one implementation of the design concept of the present invention, and the following examples are not intended to limit the scope of the invention.

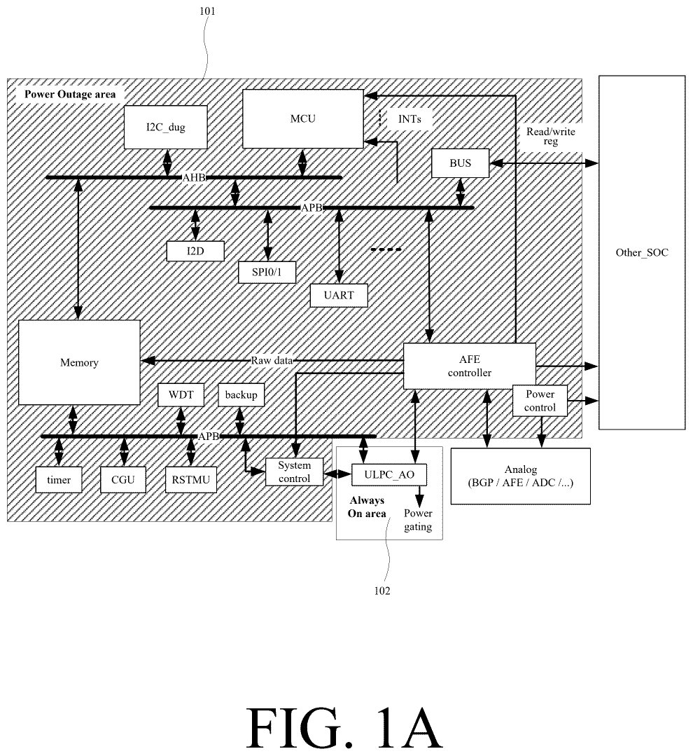

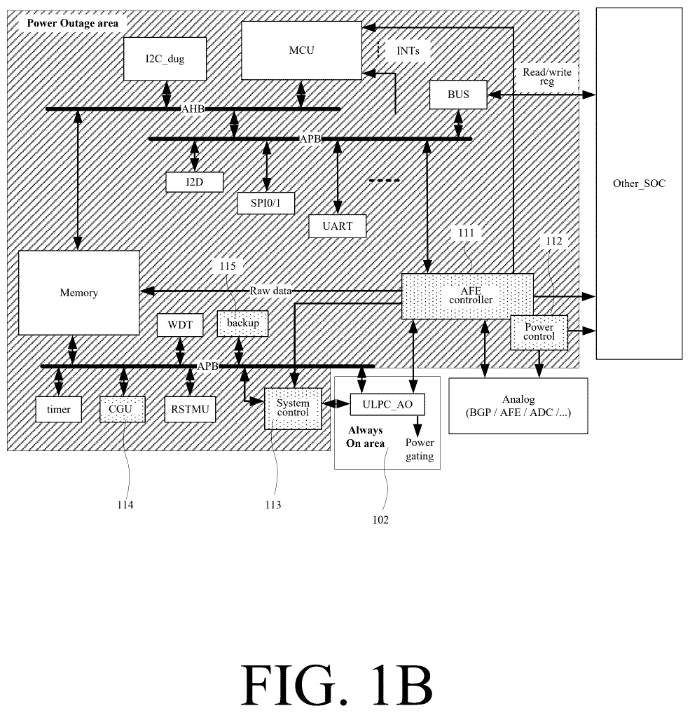

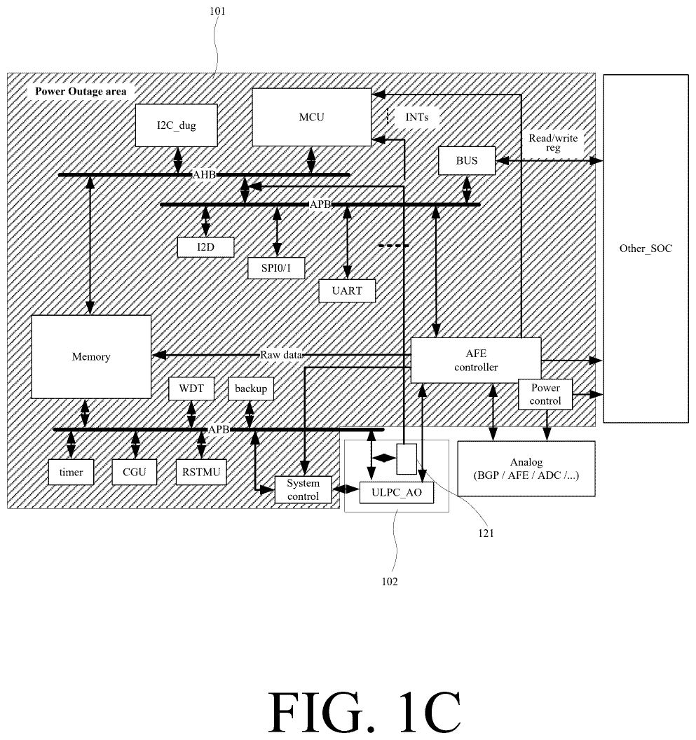

FIG. 1A illustrates a block diagram depicting an ultra-low power integrated circuit according to a preferred embodiment of the present invention. Referring to FIG. 1A, the ultra-low power integrated circuit in this embodiment may be a touch display driving circuit. The ultra-low power integrated circuit includes a functional circuit block 101 and a power consumption control block 102. The functional circuit block 101 is configured within a first power ring, while the power consumption control block 102 is configured within a second power ring. Different underlines are used here to distinguish the blocks.

In this embodiment, the entire touch display driving circuit is divided into only two blocks. The main difference between these two blocks is that the functional circuit block 101 can be completely powered off, while the power consumption control block 102 is a constant power region (always-on area). The functional circuit block 101 and the power consumption control block 102 can be configured within different power rings, in which the second power ring is continuously powered on. Furthermore, compared to the functional circuit block 101, the power consumption control block 102 is significantly smaller in both area and power consumption. Preferably, this touch display driving circuit is used in wearable mobile devices. Since the battery of wearable mobile devices is much smaller than that of handheld devices, power consumption needs to be more strictly controlled.

In normal mode, the functional circuit block 101 operates according to internal configuration settings. After a period of inactivity, wearable mobile device typically automatically switches from the normal mode to the low-power mode. Similarly, the touch display driving circuit in this embodiment also switches from the normal mode to the low-power mode. After entering low-power mode, the following five procedures are performed:

First procedure: At this point, the power consumption control block 102 controls the functional circuit block 101 to execute a power-off sequence. To prevent the functional circuit block 101 from failing to operate when returning to the normal mode, the power consumption control block 102 temporarily stores the configuration settings of the functional circuit block 101. Then, the power supply to the first power ring of the functional circuit block 101 is turned off, completely powering down the functional circuit block 101.

Second procedure: The operating clock frequency of the power consumption control block 102 is reduced to lower the power consumption of the power consumption control block 102.

Third procedure: Waiting for a preset period of time. The power consumption during this time is extremely low.

Fourth procedure: The clock frequency of the power consumption control block 102 is increased, and the power consumption control block 102 executes a power-on sequence for the functional circuit block 101, loading the temporarily stored configuration settings into the functional circuit block 101.

Fifth procedure: The functional circuit block 101 performs a wake-up determination. If the wake-up determination results in no wake-up, the process returns to the first procedure.

FIG. 1B illustrates a block diagram depicting an ultra-low power integrated circuit according to a preferred embodiment of the present invention. Referring to FIG. 1A and FIG. 1B, in the aforementioned embodiment, although the configuration settings of the functional circuit block 101 are temporarily stored, in this embodiment, it is also possible to selectively place the circuit blocks 111-115 within the power consumption control block 102, such that part of the circuitry in the internal retention register (Retention DFF) remains powered. This ensures that the settings of the aforementioned blocks do not disappear due to the transition into low-power mode.

FIG. 1C illustrates a block diagram depicting an ultra-low power integrated circuit according to a preferred embodiment of the present invention. Referring to FIG. 1A and FIG. 1C, in this embodiment, the power consumption control block 102 has additionally introduced a parameter save register 121, which temporarily stores the configuration settings of the functional circuit block 101. When the power supply to the functional circuit block 101 is restored, the configuration settings are transmitted from the parameter save register 121 to the bus in the circuit, allowing the functional circuit block 101 to operate in its original settings.

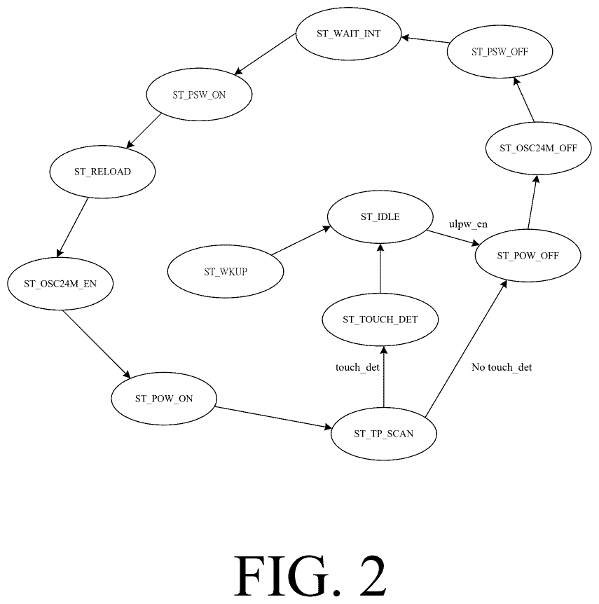

FIG. 2 illustrates a state diagram depicting the finite state machine of the ultra-low power integrated circuit according to a preferred embodiment of the present invention. In this embodiment, the operation of the aforementioned ultra-low power integrated circuit can be represented by a state diagram. The ultra-low power integrated circuit is exemplified by a touch display driving circuit. The functional circuit block 101 typically includes an analog front-end circuit block (AFE), a digital circuit block (Automatic Placement & Routing, APR), and a microprocessor circuit. The digital circuit block includes a temporary configuration memory block, which temporarily stores the configuration settings for loading them after the power-on sequence. Additionally, a system with a central processing unit (e.g., a wearable mobile device) controls the touch display driving circuit. First, the initial state is defined as the normal mode ST_WKUP. In this initial state, an interrupt signal (INT) notifies the central processing unit (CPU) of the wearable mobile device, unlocking the CPU reset, allowing the CPU to execute the code stored in the read-only memory (ROM).

In one condition, such as exceeding a predetermined time or user operation, the system enters a low power consumption mode, ST_IDLE. Next, after confirming the signal, the system enters the power-off procedure for shutting down the analog front-end circuit block, ST POW_OFF. After the power-off procedure for the analog front-end circuit block is completed, ST_POW_OFF, the clock for the digital circuit block is turned off, ST_OSC24M_OFF. Then, the power supply to the digital circuit block is turned off, and the power consumption control block 102 temporarily stores the configuration settings, ST_PSW_OFF. The power-off procedure for the analog front-end circuit block ST_POW_OFF, the clock shutdown for the digital circuit block ST_OSC24M_OFF, and the power-off for the digital circuit block ST_PSW_OFF can be referred to as the power-off sequence for the functional circuit block 101.

Next, the timing procedure ST_WAIT_INT is entered, waiting for the timer to trigger a time-out interrupt. Once the timer triggers the time-out interrupt, the power-on sequence for the functional circuit block 101 begins. First, the microprocessor circuit and certain subsystems (CPU/iSP) are kept in a stopped or sleep state, and the aforementioned timer is stopped. Then, the power supply to the digital circuit block is restored, ST_PSW_ON. Afterward, the power consumption control block 102 writes the relevant parameters of the configuration settings back to the registers in the digital circuit block, ST_RELOAD. Next, the clock signal for the oscillator is enabled and provided to the digital circuit block, waiting for the clock signal to stabilize, ST_OSC24M_EN. The analog power for the analog front-end circuit block (AFE) is then turned on, ST_POW_ON. The analog front-end circuit begins scanning, and after the scan is completed, it is determined whether a touch event has occurred, ST TP SCAN. If no touch event occurs, the system returns to the power-off procedure for the analog front-end circuit block, ST_POW_OFF, and continues the cycle.

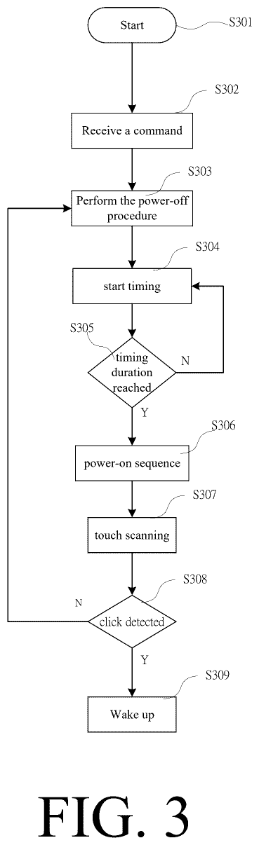

FIG. 3 illustrates a flowchart depicting the power saving method for an integrated circuit according to a preferred embodiment of the present invention. The power-saving method of this integrated circuit includes the following steps:

Step S301: Start.

Step S302: Receive a command. Switch from a normal mode to a low-power mode.

Step S303: Perform the power-off procedure. Perform the power-off procedure for the functional circuit block 101. In order to ensure that the functional circuit block 101 can still operate after power is restored, the power consumption control block 102 temporarily stores the configuration settings of the functional circuit block 101.

Step S304: Reduce frequency and start timing. At this point, the power-off mode is entered, where the operating frequency of the power consumption control block 102 is further reduced, and timing begins. In power-off mode, since the power supply to the functional circuit block is completely turned off, the power consumption of the integrated circuit is further reduced. Compared to the low-power mode mentioned above, the power consumption is further minimized, so this mode can also be referred to as the ultra-low power mode.

Step S305: Determine whether the timing duration has been reached. If not, return to Step S304 and continue timing. If it has been reached, proceed to Step S306.

Step S306: Increase frequency and perform the power-on sequence. The operating frequency of the power consumption control block 102 is increased, and the power-on sequence for the functional circuit block 101 is performed. At this point, the power consumption control block 102 loads the stored configuration settings into the functional circuit block 101 such that the functional circuit block 101 can be normally operated.

Step S307: Perform touch scanning. Enter a pre-wake-up mode, enabling the touch scanning function.

Step S308: Determine whether a touch event has occurred. If no touch event is detected, return to Step S303 and continue the cycle. If a touch event is detected, proceed to Step S309.

Step S309: Wake up the CPU of the main system. The reset of the CPU is unlocked such that the CPU can be normally operated. The CPU then sends an interrupt request to the microprocessor circuit inside the functional circuit block 101 to begin execution. When the microprocessor circuit receives the interrupt request, it re-executes ROM code (the firmware code) program and loads the ROM code into writable memory.

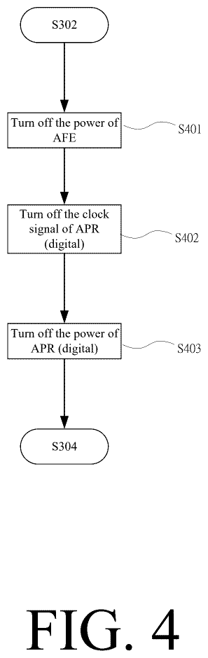

FIG. 4 illustrates a flowchart depicting the sub-steps of step S303 of the power saving method for an integrated circuit according to a preferred embodiment of the present invention. Referring to FIG. 4, Step S303 includes:

Step S401: Turn off the power of the analog front-end circuit block (AFE).

Step S402: Turn off the clock signal of the digital circuit block (APR).

Step S403: Store the configuration settings and turn off the power of the digital circuit block.

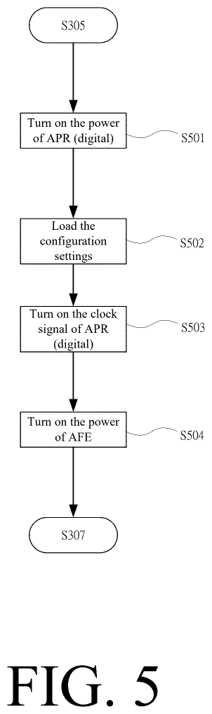

FIG. 5 illustrates a flowchart depicting the sub-steps of step S306 of the power saving method for an integrated circuit according to a preferred embodiment of the present invention. Referring to FIG. 5, Step S306 includes:

Step S501: Turn on the power of the digital circuit block (APR).

Step S502: Load the configuration settings into the digital circuit block. The power consumption control block 102 loads the aforementioned configuration settings into the functional circuit block 101 to enable normal operation.

Step S503: Turn on the clock signal of the digital circuit block (APR).

Step S504: Turn on the power of the analog front-end circuit block, allowing the touch display driving circuit to begin touch scanning.

As can be seen from the above embodiment, the system in this embodiment includes only one power consumption control block 102, which is always in an active state. Since the power consumption control block 102 consumes very little power, it manages the operation of the functional circuit block 101 in low-power mode, where the functional circuit block 101 can be completely powered off. The power-off mode and pre-wake-up mode cyclically repeats, ensuring that the system operates with minimal power consumption in low-power mode, while still allowing for a quick wake-up without affecting normal operation.

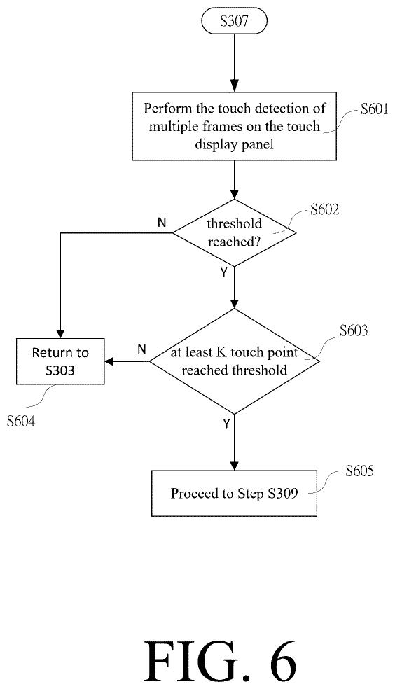

FIG. 6 illustrates a flowchart depicting the sub-steps of step S308 of the power saving method for an integrated circuit according to a preferred embodiment of the present invention. Referring to FIG. 6, Step S308 includes:

Step S601: Perform the touch detection of multiple frames on the touch display panel.

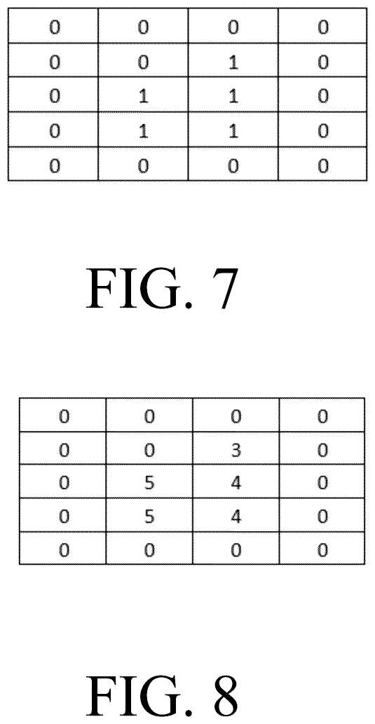

Step S602: Determine whether the number of touch points or the area range of the touch points in the multiple frames has reached a touch area threshold. In one example shown in FIG. 7, at least 5 points need to be detected as touched. FIG. 7 illustrates a schematic diagram depicting a touch detection result of step S308 according to a preferred embodiment of the present invention. In this embodiment, it assumes that a frame contains 20 touch point areas. In Step S602, if 5 points in the frame are touched, or the area range of the touch points is 5, and the threshold is 4, it indicates that the touch area threshold is met in Step S602, and Step S603 is performed for further judgment. Conversely, if Step S602 determines that the threshold is not met, the process proceeds to Step S604.

Step S603: Determine whether at least one preset touch point in the multiple frames has reached a touch count threshold, as shown in FIG. 8. In this step, determine whether at least K touch points in the multiple frames have reached the touch count threshold. FIG. 8 illustrates a schematic diagram depicting a touch detection result of step S308 according to a preferred embodiment of the present invention. In one example, it assumes that 6 frames are detected, and in Step S602, it is determined that the touch area includes at least K points (where K may be 5). Referring to FIG. 8, one touch point is touched 3 times across the 6 frames, two points are touched 4 times, and two points are touched 5 times. If the touch count threshold is 3, the result of Step S603 is affirmative, meaning that at least one of the K touch points has reached the touch count threshold, and Step S605 is performed. Conversely, if the touch count threshold is not met, the process proceeds to Step S604.

Step S604: Return to Step S303 and continue the cycle.

Step S605: Proceed to Step S309, wake up the central processor, load the ROM code program (firmware code) from the read-only memory, and return to the normal mode.

To sum up, the embodiment of the present invention provides an ultra-low power integrated circuit design method. By dividing the circuit into power consumption control blocks and functional circuit blocks, and using separate power supply rails, it is possible to selectively power off or reduce clock frequency in low power mode, such that the significant energy savings can be achieved. When entering the low power mode, the power consumption control block first stores the configuration settings of the functional block and performs a power-off sequence to turn off the power supply to the functional block, completely powering it down. At the same time, the operating clock frequency of the power consumption control block is also appropriately reduced to further lower power consumption. After a preset time, the clock frequency of the power consumption control block will be raised, and a power-up procedure for the functional circuit block is performed, and the previously stored configuration settings is loaded to resume system operation. If the system still does not need to wake up at this point, it will re-enter the low power mode and repeat the above cycle. This intelligent energy-saving design ensures minimal power consumption in low power mode while allowing for quick wake-up, without affecting normal operation. Compared with conventional energy-saving modes, the present invention can achieve greater power reduction, extending battery life, making it particularly suitable for portable devices with limited power, such as wearable devices and smartphones, significantly enhancing the user experience.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A low-power integrated circuit, comprising:
a functional circuit block; and
a power consumption control block, wherein the power consumption control block remains powered on,
wherein, when an operation mode of the low-power integrated circuit is switched from a normal mode to a low-power mode, an operation of the low-power integrated circuit comprises:
a first procedure: the power consumption control block performs a power-off sequence on the functional circuit block, then turns off the power supply to the functional circuit block, thereby completely powering down the functional circuit block;
a second procedure: reducing the operating clock frequency of the power consumption control block;
a third procedure: waiting for a preset time;
a fourth procedure: increasing the operating clock frequency of the power consumption control block, and the power consumption control block performing a power-on sequence on the functional circuit block; and
a fifth procedure: the functional circuit block performing a wake-up determination, and if the wake-up determination results in no wake-up, returning to the first procedure.

2. The low-power integrated circuit according to claim 1, wherein the functional circuit block comprises:
an analog front-end circuit block; and
a digital circuit block, comprising a configuration storage memory block for temporarily storing a configuration setting,
wherein the first procedure further comprises: the power consumption control block temporarily storing the configuration setting,
wherein the fourth procedure further comprises: the power consumption control block loading the configuration setting back into the digital circuit block.

3. The low-power integrated circuit according to claim 1, wherein, in the first procedure, the power consumption control block further comprises steps as follows:
step A, turning off a power of the analog front-end circuit block;
step B, turning off a clock signal of the digital circuit block; and
step C, storing the configuration setting and turning off a power of the digital circuit block.

4. The low-power integrated circuit according to claim 1, wherein the power consumption control block performing the power-on sequence comprises:
step A, turning on a power of the digital circuit block;
step B, loading the configuration setting into the digital circuit block;
step C, turning on a clock signal of the digital circuit block; and
step D, turning on a power of the analog front-end circuit block.

5. The low-power integrated circuit according to claim 1, wherein the low-power integrated circuit is used to drive a touch display panel, and wherein the functional circuit block performs a wake-up determination, which comprises the power consumption control block performing touch detection of multiple frames on the touch display panel, the touch detection comprising:
determining whether a touch point area in the frames reaches a touch area threshold;
determining whether at least one preset touch point reaches a touch count threshold; and
when the touch point area reaches the touch area threshold and at least one preset touch point reaches the touch count threshold, performing a wake-up sequence.

6. The low-power integrated circuit according to claim 5, wherein the functional circuit block further comprises a microprocessor circuit, and the touch display panel is controlled by a mobile system, the mobile system comprising a central processing unit, wherein the wake-up sequence comprises:
unlocking a reset of the central processing unit, enabling the central processing unit to operate normally, and then the central processing unit issuing an interrupt request to the microprocessor circuit; and
when the microprocessor circuit receives the interrupt request, re-executing a ROM code program and loading the ROM code program into writable memory.

7. A touch display driving circuit for controlling a touch display panel, wherein the touch display driving circuit comprises:
a functional circuit block; and
a power consumption control block, wherein the power consumption control block remains powered on,
wherein, when the touch display driving circuit enters a low-power mode from a normal mode, the touch display driving circuit cyclically switches between a pre-wake-up mode and a power-off mode, wherein, in the power-off mode, the power consumption control block controls the functional circuit block to be completely powered off, and in the pre-wake-up mode, the power consumption control block performs touch detection of multiple frames on the touch display panel, the touch detection comprises:
determining whether a touch point area in the frames reaches a touch area threshold;
determining whether at least one preset touch point reaches a touch count threshold; and
when the touch point area reaches the touch area threshold and at least one preset touch point reaches the touch count threshold, performing a wake-up sequence and returning to the normal mode.

8. The touch display driving circuit according to claim 7, wherein the functional circuit block further comprises a microprocessor circuit, and the touch display panel is controlled by a mobile system, the mobile system comprising a central processing unit, wherein the wake-up sequence comprises:
unlocking a reset of the central processing unit, enabling the central processing unit to operate normally, and then the central processing unit issuing an interrupt request to the microprocessor circuit; and
when the microprocessor circuit receives the interrupt request, re-executing a ROM code program and loading the ROM code program into writable memory.

9. The touch display driving circuit according to claim 7, when the touch display driving circuit enters the low-power mode from the normal mode, further comprising:
a first procedure: the power consumption control block performing a power-off sequence on the functional circuit block, entering the power-off mode, and temporarily storing a configuration setting of the functional circuit block, then completely powering off the functional circuit block;
a second procedure: reducing an operating clock frequency of the power consumption control block;
a third procedure: waiting for a preset time;
a fourth procedure: increasing a clock frequency of the power consumption control block, and the power consumption control block performing a power-on sequence on the functional circuit block, entering the pre-wake-up mode, and loading the configuration setting; and
a fifth procedure: the functional circuit block performing a wake-up determination, and if the wake-up determination results in no wake-up, return to the first procedure.

10. The touch display driving circuit according to claim 9, wherein the functional circuit block comprises:
an analog front-end circuit block; and
a digital circuit block, comprising a temporary configuration memory block used to store a configuration setting,
wherein the first procedure further comprises: the power consumption control block temporarily storing the configuration setting,
wherein the fourth procedure further comprises: the power consumption control block loading the configuration setting back into the digital circuit block.

11. The touch display driving circuit according to claim 10, wherein, in the first procedure, the power consumption control block further comprises performing steps as follows:
step A: turning off a power of the analog front-end circuit block;
step B: turning off a clock signal of the digital circuit block; and
step C: storing the configuration setting and turning off a power of the digital circuit block.

12. The touch display driving circuit according to claim 10, wherein the power consumption control block performing the power-on sequence comprises:
step A: turning on a power of the digital circuit block;
step B: loading the configuration setting into the digital circuit block;
step C: turning on a clock signal of the digital circuit block; and
step D: turning on a power of the analog front-end circuit block.

13. A power-saving method for an integrated circuit, comprising:
dividing the integrated circuit into a functional circuit block and a power consumption control block which remains powered on;
when the integrated circuit enters a low-power mode from a normal mode, the power consumption control block performs procedures, comprising:
a first procedure: performing a power-off sequence for the functional circuit block, then turning off power supply to completely power off the functional circuit block;
a second procedure: reducing an operating clock frequency of the power consumption control block;
a third procedure: waiting for a preset time;
a fourth procedure: increasing the operating clock frequency of the power consumption control block, and the power consumption control block performing a power-on sequence for the functional circuit block; and
a fifth procedure: performing a wake-up determination, and if the wake-up determination results in no wake-up, returning to the first procedure.

14. The power-saving method for an integrated circuit according to claim 13, wherein the functional circuit block comprises an analog front-end circuit block and a digital circuit block, and the digital circuit block comprises a configuration setting, wherein the first procedure comprises:
step A: turning off a power of the analog front-end circuit block;
step B: turning off a clock signal to the digital circuit block; and
step C: storing the configuration setting and turning off a power of the digital circuit block.

15. The power-saving method for an integrated circuit according to claim 13, wherein the power consumption control block performing the power-on sequence comprises:
step A: turning on a power of the digital circuit block;
step B: loading the configuration setting to the digital circuit block;
step C: turning on a clock signal to the digital circuit block; and
step D: turning on a power of the analog front-end circuit block.

16. The power-saving method for an integrated circuit according to claim 13, wherein the integrated circuit is for driving a touch display panel, wherein performing the wake-up determination comprises the power consumption control block performing a touch detection of multiple frames on the touch display panel, and the touch detection comprises:
determining whether a touch point area in the frames reaches a touch area threshold;
determining whether at least one preset touch point reaches a touch count threshold; and
when the touch point area reaches the touch area threshold, and at least one preset touch point reaches the touch count threshold, performing a wake-up sequence.

17. The power-saving method for an integrated circuit according to claim 16, wherein the functional circuit block further comprises a microprocessor circuit, and the touch display panel is controlled by a mobile system, wherein the mobile system comprises a central processing unit, and the wake-up sequence comprises:
unlocking a reset of the central processing unit so that the central processing unit operates normally, and then the central processing unit issues an interrupt request to the microprocessor circuit; and
when the microprocessor circuit receives the interrupt request, re-executing a ROM code program to load the ROM code program into writable memory.

18. A power-saving method for a touch display driver circuit, wherein the touch display driver circuit is used for controlling a touch display panel, the touch display driver circuit comprises a functional circuit block that stores a configuration setting and a power consumption control block, wherein the power consumption control block remains powered on, wherein the power-saving method for the touch display driver circuit comprises:
when entering a low-power mode from a normal mode, cyclically switching between a pre-wake-up mode and a power-off mode, wherein in the power-off mode, the power consumption control block controls the functional circuit block to be completely powered off, and in the pre-wake-up mode, performing touch detection of multiple frames on the touch display panel;
wherein the touch detection comprises:
determining whether a touch area in the frames reaches a touch area threshold; and
determining whether at least one preset touch point reaches a touch count threshold;
when the touch point area reaches the touch area threshold, and at least one preset touch point reaches the touch count threshold, performing a wake-up sequence, and returning to the normal mode.

19. The power-saving method according to claim 18, wherein the functional circuit block further comprises a microprocessor circuit, and the touch display panel is controlled by a mobile system, the mobile system comprises a central processing unit, wherein the wake-up sequence comprises:
unblocking a reset of the central processing unit, enabling the central processing unit to run normally, after which the central processing unit issues an interrupt request to the microprocessor circuit; and
when the microprocessor circuit receives the interrupt request, re-executing a ROM code program, and loading the ROM code program into writable memory.

20. The power-saving method according to claim 18, when the touch display driver circuit enters the low-power mode from the normal mode, further comprising:
a first procedure: the power consumption control block performing a power-off sequence for the functional circuit block, entering the power-off mode, and then completely turning off a power to power off the functional circuit block;
a second procedure: lowering an operating clock frequency of the power consumption control block;
a third procedure: waiting for a preset time;
a fourth procedure: increasing the operating clock frequency of the power consumption control block, and the power consumption control block performing a power-on sequence for the functional circuit block, entering the pre-wake-up mode; and
a fifth procedure: the functional circuit block performing a wake-up determination, if the wake-up determination results in no wake-up, returning to the first procedure.

21. The power-saving method according to claim 20, wherein the functional circuit block comprises:
a front-end analog circuit block; and
a digital circuit block, comprising a configuration setting storage block used to store the configuration setting,
wherein the first procedure further comprises: the power consumption control block storing the configuration setting,
wherein the fourth procedure further comprises: the power consumption control block loading the configuration setting back into the digital circuit block.

22. The power-saving method according to claim 21, wherein, in the first procedure, the power consumption control block further comprises performing steps as follows:
step A: turning off a power of the front-end analog circuit block;
step B: turning off a clock signal of the digital circuit block; and
step C: storing the configuration setting and turning off a power of the digital circuit block.

23. The power-saving method according to claim 21, wherein, wherein the power consumption control block performing the power-on sequence comprises steps as follows:
step A: turning on a power of the digital circuit block;
step B: loading the configuration setting into the digital circuit block;
step C: turning on a clock signal of the digital circuit block; and
step D: turning on a power of the front-end analog circuit block.
